(19) United States
(12) Patent Application Publication
(10) Pub. No.: US 2006/0158121 A1
(43) Pub. Date: Jul. 20, 2006

(54) Low-pressure mercury vapor discharge lamp

(76) Inventors: Marinus Cornelis Michiel Neelen, Roosendaal (NL); Frans Joseph Traksel, Roosendaal (NL)

Correspondence Address: PHILIPS INTELLECTUAL PROPERTY & STANDARDS, P.O. BOX 3001, BRIARCLIFF MANOR, NY, 10510, US

(21) Appl. No.: 10/563,840

(22) PCT Filed: Jul. 2, 2004
(86) PCT No.: PCT/IB04/51105

§ 371 Date: Jan. 5, 2006

(30) Foreign Application Priority Data
Jul. 8, 2003 (EP) 03102043.1

(51) Int. Cl. H01J 61/20; H01J 17/20

(52) U.S. Cl. 313/639

(57) ABSTRACT

Low-pressure mercury vapor discharge lamp has aa radiation-transmitting discharge vessel (10) enclosing, in a gastight manner, a discharge space (13) provided with a filling of mercury and a rare gas. The discharge vessel (10) has a discharge means (20a) for maintaining a discharge in the discharge space (13). Container (3) comprising mercury or an amalgam (4) is arranged in the discharge vessel (10). The container (3) is provided with an opening (24). The container (3) is manufactured from a glass with a transmission of less than 0.4 in the wavelength range from 0.8 to 1.5 μm. Preferably, the transmission of the glass is less than 0.25 in the wavelength range from 1.0 to 1.2 μm. Preferably, the glass comprises at least 2% by weight Fe₂O₃. Preferably, the container (3) is provided in an exhaust tube (9) in an end portion (12a) of the discharg vessel (10).

The invention relates to a low-pressure mercury vapor discharge lamp.

The invention also relates to a container containing mercury or an amalgam for use in a low-pressure mercury vapor discharge lamp.

In mercury vapor discharge lamps, mercury constitutes the primary component for the (efficient) generation of ultraviolet (UV) light. A luminescent layer comprising a luminescent material may be present on an inner wall of the discharge vessel to convert UV to other wavelengths, for example, to UV-B and UV-A for tanning purposes (sun panel lamps) or to visible radiation for general illumination purposes. Such discharge lamps are therefore also referred to as fluorescent lamps. Alternatively, the ultraviolet light generated may be used for manufacturing germicidal lamps (UV-C). The discharge vessel of low-pressure mercury vapor discharge lamps is usually circular and comprises both elongate and compact embodiments. Generally, the tubular discharge vessel of compact fluorescent lamps comprises a collection of relatively short straight parts having a relatively small diameter, whose straight parts are connected together by means of bridge parts or via bent parts. Compact fluorescent lamps are usually provided with an (integrated) lamp cap. Normally, the means for maintaining a discharge in the discharge space are electrodes arranged in the discharge space. In an alternative embodiment the low-pressure mercury vapor discharge lamp comprises a so-called electrodeless low-pressure mercury vapor discharge lamp.

In the description and claims of the current invention, the designation “nominal operation” is used to refer to operating conditions where the mercury-vapor pressure is such that the radiation output of the lamp is at least 80% of that when the light output is maximal, i.e. under operating conditions where the mercury-vapor pressure is optimal. In addition, in the description and claims, the “initial radiation output” is defined as the radiation output of the discharge lamp 1 second after switching-on of the discharge lamp, and the “run-up time” is defined as the time needed by the discharge lamp to reach a radiation output of 80% of that during optimum operation.

Low-pressure mercury-vapor discharge lamps are known comprising an amalgam. Such discharge lamps have a comparatively low mercury-vapor pressure at room temperature. As a result, amalgam-containing discharge lamps have the disadvantage that also the initial radiation output is comparatively low when a customary power supply is used to operate said lamp. In addition, the run-up time is comparatively long because the mercury-vapor pressure increases only slowly after switching-on of the lamp. Apart from amalgam-containing discharge lamps, low-pressure mercury-vapor discharge lamps are known which comprise both a (main) amalgam and a so-called auxiliary amalgam. If the auxiliary amalgam comprises sufficient mercury, then the lamp has a relatively short run-up time. Immediately after the lamp has been switched on, i.e. during pre-heating of the electrodes, the auxiliary amalgam is heated by the electrode so that it relatively rapidly dispenses a substantial part of the mercury that it contains. In this respect, it is desirable that, prior to being switched on, the lamp has been idle for a sufficiently long time to allow the auxiliary amalgam to take up sufficient mercury. If the lamp has been idle for a comparatively short period of time, the reduction of the run-up time is only small. In addition, in that case the initial radiation output is (even) lower than that of a lamp comprising only a main amalgam, which can be attributed to the fact that a comparatively low mercury-vapor pressure is adjusted in the discharge space by the auxiliary amalgam. An additional problem encountered with comparatively long lamps is that it takes comparatively much time for the mercury liberated by the auxiliary amalgam to spread throughout the discharge vessel, so that after switching-on of such lamps, they demonstrate a comparatively bright zone near the auxiliary amalgam and a comparatively dark zone at a greater distance from the auxiliary amalgam, which zones disappear after a few minutes.

In addition, low-pressure mercury-vapor discharge lamps are known which are not provided with an amalgam and contain only free mercury. These lamps, also referred to as mercury discharge lamps, have the advantage that the mercury-vapor pressure at room temperature and, hence, the initial radiation output are relatively high as compared with amalgam-containing discharge lamps and as compared with discharge lamps comprising a (main) amalgam and an auxiliary amalgam. In addition, the run-up time is comparatively short. After having been switched on, comparatively long lamps of this type also demonstrate a substantially constant brightness over substantially the whole length, which can be attributed to the fact that the vapor pressure (at room temperature) is sufficiently high at the time of switching on these lamps.

EP-A 0 772 219 discloses a low-pressure mercury discharge lamp provided with a radiation-transmitting discharge vessel which is closed in a gastight manner and has an ionizable filling comprising mercury, while a container with a glass wall having an opening is arranged in the discharge vessel, and the lamp is in addition provided with means for maintaining an electric discharge in a discharge space surrounded by the discharge vessel. The container is accessible to radiation of at least a wavelength lying in a range from 100 nm to 5 μm from outside the discharge vessel through a wall portion thereof, and the wall of the container has an absorption coefficient for this radiation which amounts to at least ten times that of the wall portion of the discharge vessel.

A drawback of the known low-pressure mercury vapor discharge lamp is that opening the container during the manufacture of the low-pressure mercury vapor discharge lamp is relatively complicated.

The invention has for its object to eliminate the above disadvantage wholly or partly. According to the invention, a low-pressure mercury vapor discharge lamp of the kind mentioned in the opening paragraph for this purpose comprises:

a radiation-transmitting discharge vessel enclosing, in a gastight manner, a discharge space provided with a filling of mercury and a rare gas, the discharge vessel comprising discharge means for maintaining a discharge in the discharge space,

a container comprising mercury or an amalgam being arranged in the discharge vessel, the container having an opening,

the container having a glass wall,

the glass wall having a transmission of less than 0.4 in the wavelength range from 0.8 to 1.5 μm.

A glass wall with a transmission of less than 0.4 in the wavelength range from 0.8-1.5 μm has a relatively high absorption (above 0.6) for radiation in the wavelength range. As a consequence the container can be locally melted relatively easily during manufacture of the low-pressure mercury vapor discharge lamp. Normally, a Nd:YAG laser is employed for providing the opening in the container during manufacture of the low-pressure mercury vapor discharge lamp. Such a laser has a radiation wavelength of approximately 1.06 μm. The glass in the known low-pressure mercury vapor discharge lamp has a transmission in the wavelength range from 0.8 to 1.5 μm of more than 0.6.

The absorption of the glass is dependent of the thickness of the glass. The thickness of the wall of the container in the low-pressure mercury vapor discharge lamp according to the invention is normally in the range from 0.2 to 0.7 mm. In this range of wall thicknesses, 50 to 80% of the radiation energy of the laser is preferably absorbed in the glass.

The greater the difference between the transmission characteristics of the glass material of the container compared with the glass material of the wall of the discharge vessel, the more easily the opening is provided in the container. For providing the opening in the container, the laser light travels through the wall of the discharge vessel and reaches the container provided with the mercury or with the amalgam. To reduce or to avoid damage to (the wall of) the discharge vessel (or any layers provided thereon), the transmission of the glass material of the wall of the discharge vessel has to be relatively high for the laser radiation while at the same time the transmission of the glass material of the container has to be relatively low in the wavelength range where the laser is effective.

According to the invention, the provision of an opening in the container during the manufacture of the low-pressure mercury vapor discharge lamp according to the invention has become relatively easy.

Preferably, the transmission of the glass wall is less than 0.25 in the wavelength range from 1.0 to 1.2 μm. In this preferred embodiment of the low-pressure mercury vapor discharge lamp according to the invention, the transmission of the glass wall of the container has been tuned to the laser radiation employed for providing the opening in the container during manufacture of the low-pressure mercury vapor discharge lamp. A relatively high absorption (above 0.75) in the preferred wavelength range from 0.8 to 1.5 μm makes the local melting of the container relatively easy whereas the wall of the discharge vessel is hardly affected by the laser radiation because of the relatively high transmission of the glass material of the wall of the discharge vessel.

A preferred embodiment of the low-pressure mercury vapor discharge lamp according to the invention is characterized in that the glass wall is manufactured of a glass containing ferric oxide. The transmission of radiation in the wavelength range from 0.7 to 2 μm is suppressed by the inclusion of ferric oxide (Fe₂O₃) in the glass wall of the container.

Preferably, the glass wall comprises at least 2% by weight Fe₂O₃.

A preferred embodiment of the low-pressure mercury vapor discharge lamp according to the invention is characterized in that the glass wall comprises:

60-75% by weight SiO₂,

0.1-3% by weight B₂O₃,

0.1-7% by weight Al₂O₃,

0.1-2.5% by weight LiO₂,

5-12% by weight Na₂O,

2-9% by weight K₂O,

0.1-3% by weight MgO,

0.1-5% by weight CaO,

5-15% by weight BaO, and

2-7% by weight Fe₂O₃.
Such a glass resembles a glass called “Reed-glass”. Reed-glasses have a relatively high absorption and also a corresponding relatively low transmission for IR-radiation. The absorption characteristics of the preferred glass composition are mainly determined by the presence of ferric oxide in the glass. The composition of the preferred composition of the glass wall is chosen to be such that a minimum in the transmission of the glass wall is obtained in the radiation wavelength range from 0.7 to 2 μm, preferably in the wavelength range from 0.7 to 2 μm.

Preferably, the container has a glass wall which is substantially free of lead. Such a glass material is environmentally friendly and fulfills the (legislative) trend prohibiting the use of materials which burden the environment. This is in particular the case if the discharge lamps are injudiciously processed after the end of their lifetime.

These and other aspects of the invention are apparent from and will be elucidated with reference to the embodiments described hereinafter.

In the drawings:

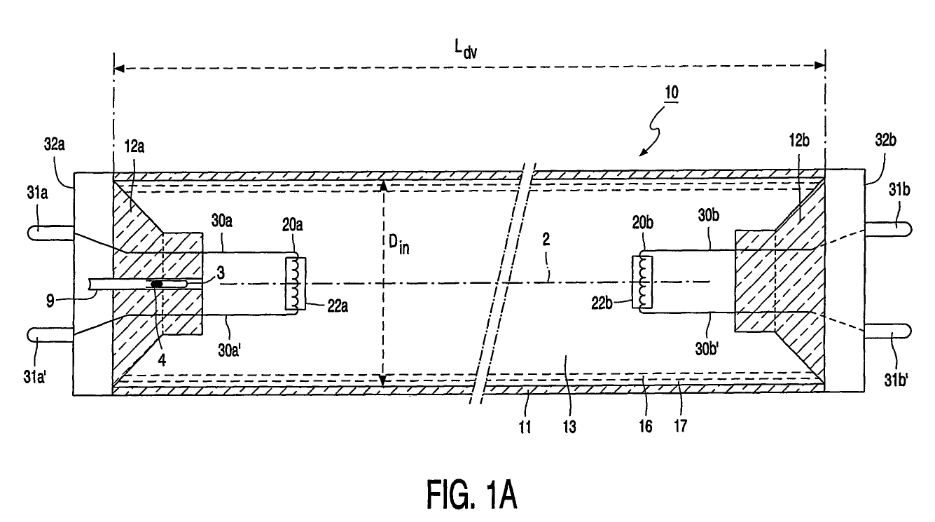

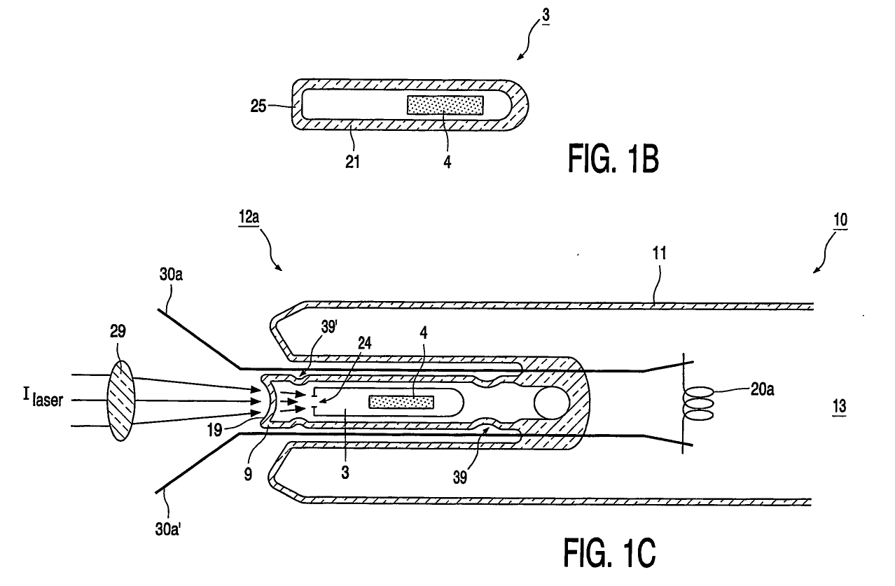

FIG. 1A is a cross-sectional view of an embodiment of the low-pressure mercury-vapor discharge lamp in accordance with the invention;

FIG. 1B shows a container comprising mercury or an amalgam;

FIG. 1C shows a detail of FIG. 1A, and

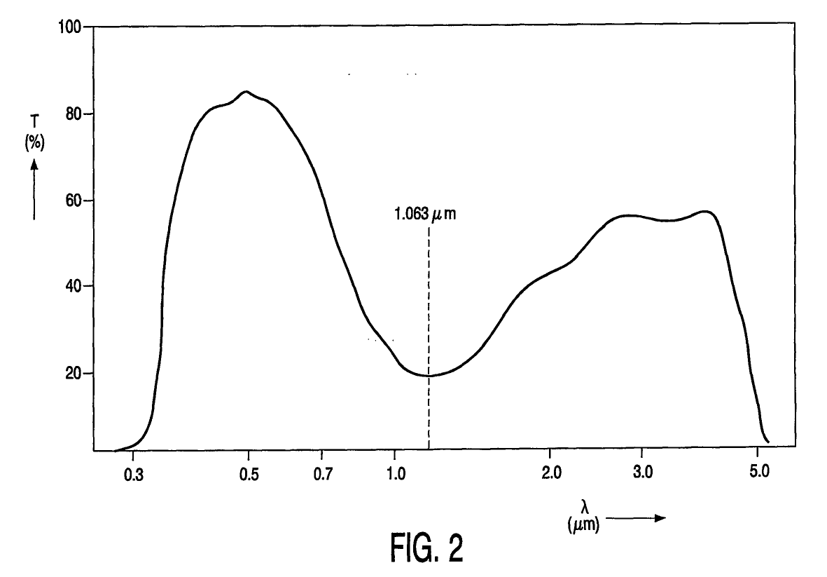

FIG. 2 shows the transmission of a glass (thickness 0.5 mm) with a transmission of less than 0.2 at a wavelength of 1.06 μm.

The Figures are purely diagrammatic and not drawn to scale. Notably, some dimensions are shown in a strongly exaggerated form for the sake of clarity. Similar components in the Figures are denoted as much as possible by the same reference numerals.

FIG. 1A shows a low-pressure mercury-vapor discharge lamp comprising a glass discharge vessel having a tubular portion 11 about a longitudinal axis 2. The discharge vessel 10 transmits radiation generated in the discharge vessel 10 and is provided with a first and a second end portion 12a; 12b, respectively. In this example, the tubular portion 11 has a length L_{dv} of 120 cm and an inside diameter Dᵢₙ of approximately 14 mm. The discharge vessel 10 encloses, in a gastight manner, a discharge space 13 containing a filling of mercury and an inert gas mixture comprising, for example, argon. In the example of FIG. 1A, the side of the tubular portion 11 facing the discharge space 13 is provided with a protective layer 17. In fluorescent discharge lamps, the side of the tubular portion 11 facing the discharge space 13 is in addition coated with a luminescent layer 16 which comprises a luminescent material (for example a fluorescent powder) which converts the ultraviolet (UV) light generated by fallback of the excited mercury into (generally) visible light.

In the example of FIG. 1A, discharge means for maintaining a discharge in the discharge space 13 are electrodes 20a; 20b arranged in the discharge space 13, said electrodes 20a; 20b being supported by the end portions 12a; 12b. Each electrode 20a; 20b is a winding of tungsten covered with an electron-emitting substance, in this case a mixture of barium oxide, calcium oxide and strontium oxide. Current-supply conductors 30a, 30a′; 30b, 30b′ supporting the respective electrodes 20a; 20b pass through the end portions 12a; 12b and issue from the discharge vessel 10 to the exterior. The current-supply conductors 30a, 30a′; 30b, 30b′ are connected to contact pins 31a, 31a′; 31b, 31b′ which are secured to lamp caps 32a, 32b.

In the example shown in FIG. 1A, each electrode 20a; 20b is surrounded by an electrode shield 22a; 22b which is preferably made from a ceramic material. Preferably, the electrode shield 22a; 22b is made from a ceramic material comprising aluminum oxide. Particularly suitable electrode shields are manufactured from so-called densely sintered Al₂O₃, also referred to as DGA. An alternative embodiment of the low-pressure mercury vapor discharge lamp comprises the so-called electrodeless discharge lamps, in which the discharge means for maintaining an electric discharge are situated outside a discharge space surrounded by the discharge vessel. Generally, the discharge means are formed by a coil provided with a winding of an electric conductor, with a high-frequency voltage, for example having a frequency of approximately 3 MHz, being supplied to said coil in operation. In general, said coil surrounds a core of a soft-magnetic material. In the example of FIG. 1A (see FIGS. 1B and 1C for more details), the end portion with reference numeral 12a is provided with an exhaust tube 9 comprising a container 3 containing mercury or an amalgam 4.

FIG. 1B shows a container 3 comprising mercury or an amalgam 4 showing the situation during manufacture of the low-pressure mercury vapor discharge lamp while the container 3 is still closed. The container 3 is kept closed until the desired atmosphere has been created in the discharge vessel 10 (after pumping and tipping-off of the exhaust tube 9). The container 3 is provided with a glass wall 21. In the example of FIG. 1A, the average thickness of the glass wall 21 is approximately 0.3 mm. In addition, the container 3 comprises a portion 25 which is substantially flat. When the container 3 is opened during manufacture of the discharge lamp, the opening 24 in the container 3 is preferably provided in the substantially flat portion 25 of the container 3.

The glass wall of the container 3 has a transmission of less than 0.4 in the wavelength range from 0.8 to 1.5 μm, preferably, the transmission of the glass wall is less than 0.25 in the wavelength range from 1.0 to 1.2 μm. The greater the difference between the transmission characteristics of the material of the glass wall of the container 3 and that of the material of the glass wall of the discharge vessel 10, the more easily the opening 24 (see FI. 1C) is provided in the container.

In principle only the (substantially flat) portion 25 of the container 3 has to be manufactured from the glass according to the invention. The remainder of the container 3 may be manufactured from standard glass. However, it is generally more convenient to fabricate the entire container with the glass according to the invention. In the example of FIG. 1C, the (substantially flat) portion 25 is provided at an end portion of the container. In an alternative embodiment, the (substantially flat) portion 25 is provided in a side wall of the container.

FIG. 1C shows a detail of FIG. 1A. FIG. 1C schematically shows that the container 3 is provided in an exhaust tube 9 in an end portion 12a of the discharge vessel 10. The end portion 12a supports the electrode 20a extending into the discharge space 13 via the current-supply conductors 30a, 30a′. In the situation of FIG. 1C, the mercury of amalgam 4 is present in the container 3, the container 3 being provided with an opening 24 in the (substantially flat) portion 25 of the container 3. In addition, FIG. 1C shows the laser beam indicated by Iₗₐₛₑᵣ while the opening 24 is being provided in the container 3. The laser beam is focused (via a lens 29) through the tipping-off membrane 19 of the exhaust tube 9. Preferably, the tipping-off membrane 19 in the exhaust tube 9 is of a concave shape (see FIG. 1C). Normally, a Nd:YAG laser is employed for providing the opening in the container during manufacture of the low-pressure mercury vapor discharge lamp. Such a laser has a radiation wavelength of 1.063 μm.

In order to match the radiation wavelength of the laser, the container 3 is preferably manufactured from a glass containing ferric oxide. Preferably, the glass comprises at least 2% by weight Fe₂O₃. Reed-glass comprising Fe₂O₃ exhibiting a relatively high absorption for IR-radiation is a very suitable material. The preferred glass composition of the container 3 according to the invention is chosen such that a minimum in the transmission of the glass is obtained in the radiation wavelength range from 0.7 to 2 μm, preferably in the wavelength range from 0.7 to 2 μm.

A very suitable embodiment of the low-pressure mercury vapor discharge lamp according to the invention is characterized in that the glass comprises:

71% by weight SiO₂,

1.5% by weight B₂O₃,

3.4% by weight Al₂O₃,

1.1% by weight LiO₂,

11% by weight Na₂O,

2.8% by weight K₂O,

0.08% by weight MgO,

0.03% by weight CaO,

6.4% by weight BaO,

<0.001% by weight PbO,

0.05% by weight MnO,

3% by weight Fe₂O₃,

<0.1% by weight As₂O₃,

0.06% by weight Sb₂O₃,

0.1% by weight SrO.

The glass according to this preferred embodiment of the invention is substantially a lead-free glass. FIG. 2 shows the transmission of the glass according to the preferred embodiment of the invention. The glass has a thickness of 0.5 mm and exhibits a transmission of less than 0.2 at a wavelength of 1.06 μm. Such a glass is very suitable for use as a material for the wall of the container 3.

During the manufacture of the discharge lamp, the glass container 3 is provided in the exhaust tube 9 in the form of a tubular projecting portion (see FIG. 1C) of the discharge vessel 10. The glass container is held between first constrictions 39 and second constrictions 39′ on either side in the exhaust tube 9. The container 3 contains an amalgam 4 of 60 mg of an alloy comprising Bi70In30 (at%/at%) with 3 mg mercury and argon under a pressure of 10 mbar. After the discharge vessel 10 has been evacuated through the exhaust tube 9 and has been provided with a filling of rare gas, the discharge vessel 10 is closed in that the exhaust tube 9 is fused at its free end resulting in (the tipping-off membrane 19 in FIG. 1C). As a next step, the container 20 is heated from the outside with infrared radiation. The glass of the container 3 is softened during the irradiation. As a next step, the discharge lamp is passed with its exhaust tube 9 along a radiation beam of a Nd-YAG laser (see FIG. 1C).

The radiation beam has a power of approximately 30 W and a diameter of approximately 0.6 mm at the focusing point. The wavelength of the radiation beam of the laser is 1063 nm. The heat generated through absorption of the radiation in the wall portion 25 (see FIG. 1B) of the container 3 causes the glass to melt, so that an opening 24 (see FIG. 1C) is created in the glass wall 21 of the container 3. A continuous laser is used in the embodiment described. Alternatively, however, a pulse-operated laser may be used. It is possible to supply the rare gas filling from the container after the discharge vessel 10 of the lamp has been closed instead of providing the discharge vessel with a rare gas filling before it is closed.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A low-pressure mercury vapor discharge lamp comprising:
a radiation-transmitting discharge vessel (10) enclosing, in a gastight manner, a discharge space (13) provided with a filling of mercury and a rare gas,
the discharge vessel (10) comprising discharge means for maintaining a discharge in the discharge space (13),
a container (3) comprising mercury or an amalgam (4) being arranged in the discharge vessel (10), the container (3) having an opening (24),
the container (3) having a glass wall (21),
the glass wall having a transmission of less than 0.4 in a wavelength range from 0.8 to 1.5 μm.

2. A low-pressure mercury vapor discharge lamp as claimed in claim 1, characterized in that the transmission of the glass wall is less than 0.25 in a wavelength range from 1.0 to 1.2 μm.

3. A low-pressure mercury vapor discharge lamp as claimed in claim 1, characterized in that the glass wall is manufactured from a glass containing ferric oxide.

4. A low-pressure mercury vapor discharge lamp as claimed in claim 3, characterized in that the glass wall comprises at least 2% by weight Fe₂O₃.

5. A low-pressure mercury vapor discharge lamp as claimed in claim 3, characterized in that the glass wall comprises:
60-75% by weight SiO₂,
0.1-3% by weight B₂O₃,
0.1-7% by weight Al₂O₃,
0.1-2.5% by weight LiO₂,
5-12% by weight Na₂O,
2-9% by weight K₂O,
0.1-3% by weight MgO,
0.1-5% by weight CaO,
5-15% by weight BaO, and
2-7% by weight Fe₂O₃.

6. A low-pressure mercury vapor discharge lamp as claimed in claim 5, characterized in that the glass wall is substantially free from lead.

7. A low-pressure mercury vapor discharge lamp as claimed in claim 1, characterized in that the opening (24) in the container (3) is provided in a portion (25) of the container (3), which portion (25) is substantially flat.

8. A low-pressure mercury vapor discharge lamp as claimed in claim 1, characterized in that the container (3) is provided in an exhaust tube (9) in an end portion (12a) of the discharge vessel (10).

9. A container (4) containing mercury or an amalgam (4) for use in a low-pressure mercury vapor discharge lamp according to claim 1.
